(19) United States
(12) Patent Application Publication
(10) Pub. No.: US 2008/0078456 A1
(43) Pub. Date: Apr. 3, 2008

(54) HYDROSTATIC VARIABLE UNIT WITH A SERVO SYSTEM AND A VALVE UNIT CONTROLLING THE SERVO SYSTEM

(75) Inventor: Reinhardt THOMS, Neumunster (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/772,279

(22) Filed: Jul. 2, 2007

(30) Foreign Application Priority Data
Oct. 2, 2006 (DE) 102006046854.6

(51) Int. Cl. F15B 11/00; F15B 13/01; F15B 20/00

(52) U.S. Cl. 137/488; 137/485

(57) ABSTRACT

The invention relates to a hydrostatic variable unit with a servo system bringing about the control of the hydrostatic unit and with a valve unit controlling the servo system, the valve unit comprising two magnetically actuated proportional pressure-reducing valves which respectively act upon one of the sides of a servo system, which sides operate counter to each other, and having a safety function which, in the event of an incident, transfers the servo system into a safety position. The safety function is realized by at least one of the proportional pressure-reducing valves being designed at the same time as a pilot valve for activating and deactivating the second proportional pressure-reducing valve.

### BACKGROUND OF THE INVENTION

The invention relates to a hydrostatic variable unit 5 with a servo system bringing about the adjustment of the hydrostatic unit and with a valve unit controlling the servo system, in accordance with the features of Claim 1.

Valve units for controlling the servo system of hydrostatic units, which are referred to as controls, serve to change the displacement volume of the hydraulic units and therefore to control the power consumption rates of hydrostatic transmissions. If transmissions of this type are used in propel drives, for example, of heavy construction machines or harvesting machines, then, for example, driving speed and tractive effort are determined via the controls.

If controls fail, risky situations arise which, under some circumstances, may involve vehicles not stopping, contrary to the drivers signal, but simply continuing to move, or unexpected accelerations or steering movements occurring, or the machines abruptly stopping, which is not any less hazardous.

There are many reasons for failure, in particular during operation under rough conditions to which relevant machines are exposed. These reasons include jamming control pistons, broken mechanical parts, short-circuiting in electric control lines, broken electric or hydraulic lines, etc.

A safety function is therefore generally superimposed 35 on relevant valve units, the safety function ensuring that, in certain incidents, the hydraulics, under a control within a predetermined time, is transferred into a safety position, so that, for example, the vehicle brakes and stops in a sufficiently gentle manner. Depending on the field of use of the hydrostatic variable unit and the incidents which are to be made safe, complicated hydraulic and/or electric circuits are required for this safety function. For example, at least one further solenoid valve is required for this purpose which supplies the valve unit with pressure, in the event of incident, interrupts the supply of pressure and hydraulically controls a bypass piston which bypasses the servo sides. In each case, further valves are required for this purpose which valves themselves can again be a source of possible failures.

The invention is based on the object of providing a hydrostatic variable unit with an improved safety function.

### SUMMARY OF THE INVENTION

According to the invention, the hydrostatic variable unit has a servo system bringing about the adjustment of the hydrostatic unit and a valve unit controlling the servo system, the valve unit comprising two magnetically actuated proportional pressure-reducing valves which respectively act upon one of the sides of a servo system, which sides operate counter to each other. A safety function is superimposed on the valve unit and, in the event of an incident, transfers the servo system into a safety position. The safety function is realized by at least one of the proportional pressure-reducing valves being designed at the same time as a pilot valve for activating and deactivating the second proportional pressure-reducing valve.

Generally, for embodiments of hydraulic units with two electric proportional pressure-reducing valves, only one of the valves is active in each case while the other is not simultaneously required and is in the inoperative state. This circumstance is used in order, with the valve not required at the particular moment, to realize the safety function which thereby manages without an additional actuator and with simpler electronic activation.

The proportional pressure-reducing valve operating as the pilot valve is preferably assigned a control piston which, as a function of its position, activates or deactivates the servo side assigned to the second proportional pressure-reducing valve. In this case, the proportional pressure-reducing valves are advantageously mutually designed in each case as a pilot valve for activating and deactivating the respectively other proportional pressure-reducing valve.

In a development of the invention, a single control piston which is common to both proportional pressure-reducing valves is provided, the control piston advantageously having a spring-centered neutral position.

The spring centering of the control piston can be 25 realized by two identical centering devices on both sides of the control piston, these centering devices each having a rod guide with a spring preloaded thereon and with a disc which is displaceable in one direction and has a stop in the opposite direction. This results in a compact constructional unit which can simply be attached to different variable units or servo systems. In this case, the control piston is preferably arranged between opposite flanges of solenoids in such a manner that the flanges seal the control-piston bore.

The deactivation of the proportional pressure-reducing valve preferably comprises the interruption of the control lines between the proportional pressure-reducing valve and its assigned servo side which is furthermore preferably relieved of load towards the tank.

Depending on the embodiment, during deactivation both servo sides are relieved of load simultaneously towards the tank and/or both servo sides are connected to each other with the pressure being equalized.

In a further refinement of the invention, the 10 deactivation comprises the interruption of the control lines for supplying pressure, for the second proportional pressure-reducing valve, the control lines preferably being relieved of load towards the tank. In addition, at least one servo side can be relieved of load towards the tank and/or both servo sides can be bypassed.

In an advantageous development of the invention, different throttling with a different delay of the tank-discharge operation is provided in the tank-discharge operations of the servo sides, so that the volumetric displacement of the hydrostatic unit is reduced in relation to the drop.

Further features and advantages of the invention emerge from the description below of exemplary embodiments.

### BRIEF DESCRIPTION OF THE DRAWINGS

In the drawings:

FIG. 1 shows a first embodiment of the hydrostatic variable unit according to the invention;

FIG. 2 shows the embodiment according to FIG. 1 when one of the proportional pressure-reducing valves is active;

FIG. 3 shows the embodiment according to FIG. 1 with two activated proportional pressure-reducing valves;

FIG. 4 shows a second embodiment of the hydrostatic variable unit according to the invention;

FIG. 5 shows a third embodiment of the hydrostatic variable unit according to the invention with two proportional pressure-reducing valves and a common control piston;

FIG. 6 shows the third embodiment with an activated proportional pressure-reducing valve which acts as a pilot valve;

FIG. 7 shows the third embodiment with an active servo side Sl;

FIG. 8 shows the third embodiment with an active servo side Sl and deactivation of the non associated proportional pressure-reducing valve;

FIG. 9 shows the third embodiment with an active servo side S2;

FIG. 10 shows the valve arrangement with the common control piston in a centered position;

FIG. 11 shows the valve arrangement with the common control piston in the deflected position.

### DETAILED DESCRIPTION OF THE PREFERRED EMBODIMENTS

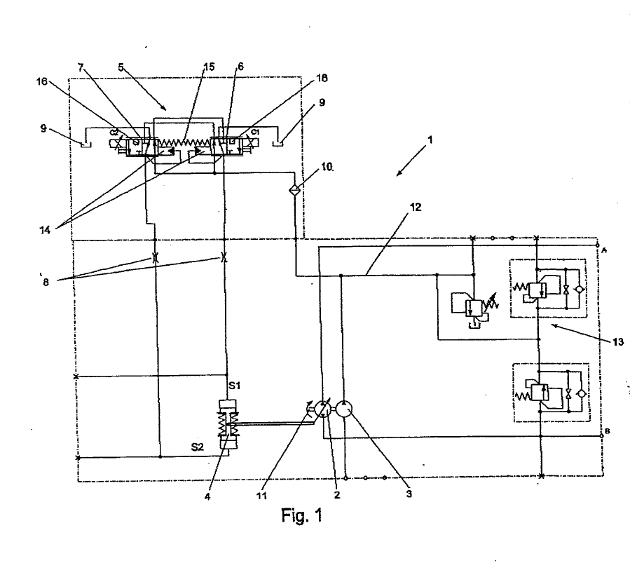

FIGS. 1 to 3 illustrate a first embodiment of the hydrostatic variable unit 1 according to the invention in various operating states. In this example, the variable unit comprises a pump 2 which is driven via the drive shaft 11 and the working lines of which lead to the connections A and B. An auxiliary pump 3, for example the charging pump of the system, is also driven by the drive shaft 11 and supplies an auxiliary circuit 12 with a certain hydraulic pressure. An arrangement of positive-pressure valves 13 makes the system safe as standard.

The volumetric flow supplied by the pump 2 is set by the servo system 4 with which, for example, the inclined swashplate of the pump 2 can be adjusted. In the present case, the servo system comprises a piston which can be acted upon from both sides with pressure and can thus be moved to and fro in the direction of the longitudinal axis of the piston. This movement is controlled by the valve unit (control) 5 which has a first and second proportional pressure-reducing valve 6, 7 which are respectively actuated by a proportional solenoid Cl, C2. The proportional pressure-reducing valves 6, 7 are respectively assigned to one of the sides Si, S2 of the servo system 4, which sides operate counter to each other, and are connected to the respective servo side via a line in which an orifice 8 brings about a suitable time constant in the response behavior of the servo system. The servo system 4 is supplied by the auxiliary pump 3 via the auxiliary circuit 12. A screen element 10 fitted in the auxiliary circuit 12 serves as a filter in order to keep dirt away from the valve unit 5. One or more restoring springs 15 ensure that the proportional pressure-reducing valves 6, 7 are reset into their starting position when the solenoids Cl, C2 are not energized.

A mechanical recycling of the current pivoting angle or of the servo-piston position to the valve unit 5 is not provided. Instead, there is a pressure-recycling means 14 with which the pressure prevailing at the servo piston is fed back to the respective proportional pressure-reducing valve.

In the valve unit 5, the safety function is realized by each of the proportional pressure-reducing valves, which, on its own, as customary controls the pressurization on one side of the servo piston and therefore the displacement thereof in one direction, acting at the same time as a pilot valve for activating or deactivating the other proportional pressure-reducing valve.

The operation is explained in the comparison of FIGS. 35 1 to 3.

In FIG. 1, both proportional pressure-reducing valves 6, 7 are illustrated in the non active state. The hydraulic unit is in the neutral position. Both sides Sl, S2 of the servo system 4 are relieved of load towards the tank 9. Each proportional Pressure-reducing valve, on its own, can displace the servo piston in the predetermined direction in the conventional manner as long as the second proportional pressure-reducing valve is not activated.

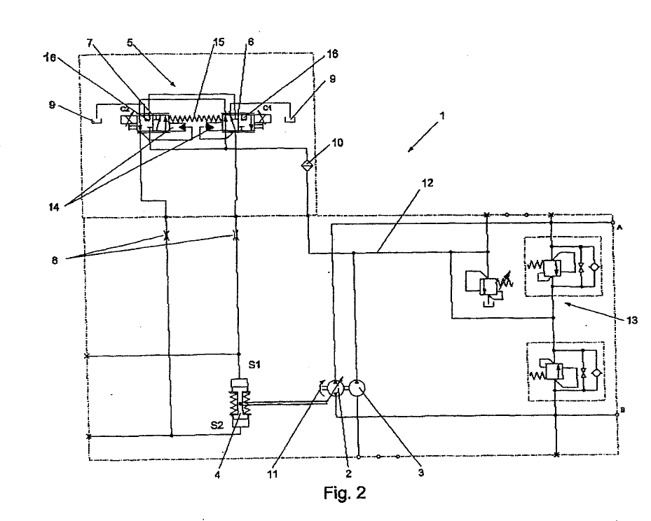

In FIG. 2, the proportional pressure-reducing valve 7 is active. It conducts the hydraulic pressure of the auxiliary circuit 12, in accordance with the ratio of forces, between the energized solenoid C2 and the counterforce built up by the pressure-recycling means 14 and the restoring spring 15 to the lower servo side S2 in the drawing. In this case, the upper servo side 15 51 is relieved of load towards the tank 9 via the inactive proportional pressure-reducing valve 6.

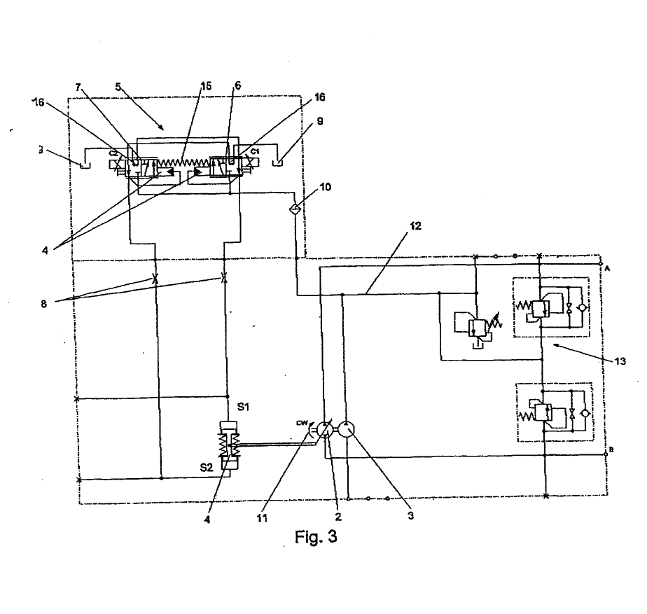

FIG. 3 shows the deactivation of the previously active proportional pressure-reducing valve 7 by the proportional pressure-reducing valve 6 which is now likewise activated and acts here as a pilot valve. If, namely, the proportional pressure-reducing valve 6 is activated at the same time, then the two valves mutually prevent each other from adjusting the servo system because they mutually cut off the supply of pressure. Both servo sides Si, S2 are thus relieved of load towards the tank 9. By means of appropriate orificing 16 by means of the orifices provided in the flow paths, the hydrostatic variable unit is pivoted back in a controlled manner within a defined time.

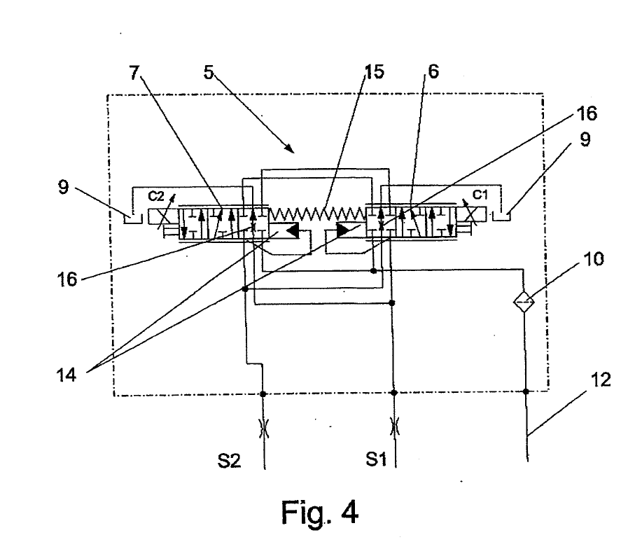

The exemplary embodiment described with reference to FIGS. 1 to 3 is sufficient in order to ensure adequate safety in many applications. Only when there is a cable break at the active solenoid, i.e. when the system returns from the operating state illustrated in FIG. 2 into the operating state of FIG. 1, it is not possible for the other valve to prevent the variable unit from possibly pivoting back too rapidly. FIG. 4 shows a second embodiment which also permits a suitable reaction to the abovementioned cable break. The valve unit 5 is illustrated in the neutral position of the hydrostatic variable unit which, apart from the valve unit, corresponds exactly to that of FIGS. 1 to 3. The valve unit 5 again controls the servo system, which is supplied via the auxiliary circuit 12, and has two proportional pressure-reducing valves 6, 7 which also mutually act as the pilot valve. The pressure-recycling means 14 and the spring system 15 correspond to the identically denoted components of FIGS. 1 to 3, as does the filter system 10. In the phase illustrated, the two proportional pressure-reducing valves 6, 7 are inactive and both servo sides are relieved of load towards the tank 9.

By means of a slight, as it were subliminal, energization of the solenoid of the first proportional pressure-reducing valve 6, the spool thereof is displaced by a comparatively small distance. In the process, it takes up a first position, the central position of the valve 6 shown in FIG. 4, in which the second proportional pressure-reducing valve 7 is supplied with pressure. At the same time, the connection from its servo side to the tank is interrupted, and the servo side of the first proportional pressure-reducing valve 6 is connected to the tank. The second proportional pressure-reducing valve 7 is now operationally ready. By means of regular energization of the second proportional pressure-reducing valve 7, the associated servo side is pressurized, as already described in conjunction with FIG. 2. If the current to the first proportional pressure-reducing valve 6 is interrupted, the servo system is returned again into neutral via orifices. When there is a cable break at the active second proportional pressure-reducing valve 7, the oil volume in the associated servo cylinder is first of all locked in. Only when the current to the first proportional pressure-reducing valve 6 is interrupted is the servo cylinder then relieved of load in a controlled manner.

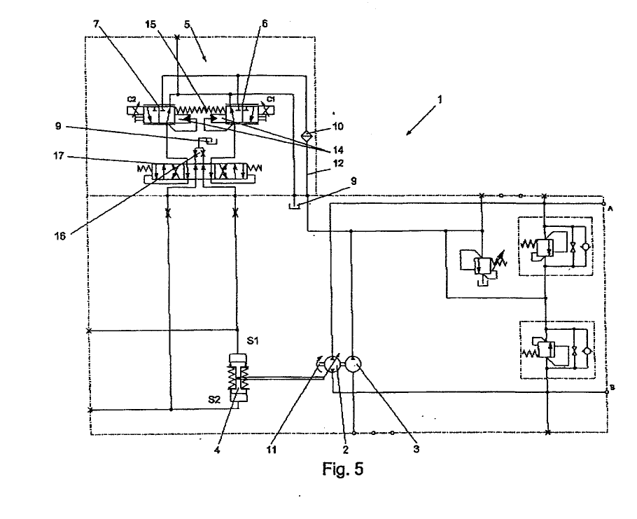

FIG. 5 shows a third exemplary embodiment of the hydrostatic variable unit according to the invention with two proportional pressure-reducing valves and a common control piston. As in the preceding examples, a pump 2 with the working lines A, B and an auxiliary pump 2, which are both driven via the drive shaft 11, are provided therein. The auxiliary circuit 12 supplies the servo system 4 which is controlled by the valve unit 5 with the proportional pressure-reducing valves 6, 7 and the common control piston 17. As in the previously described examples, a pressure-recycling means 14 and a spring system 15 for restoring the valves into the starting position are provided.

In FIG. 5, the system is in its starting position, 20 i.e. the common control piston 17 is in a centered position. Both servo sides Sl and S2 are bypassed via orifices 16 for orificing the fluid flow and at the same time are relieved of load towards the tank 9. The two together is not absolutely and always required. If appropriate, only a short-circuit or only relieving of load to the tank may be provided.

The operation of the valve unit 5 is clear from the comparison of FIGS. 5 to 9.

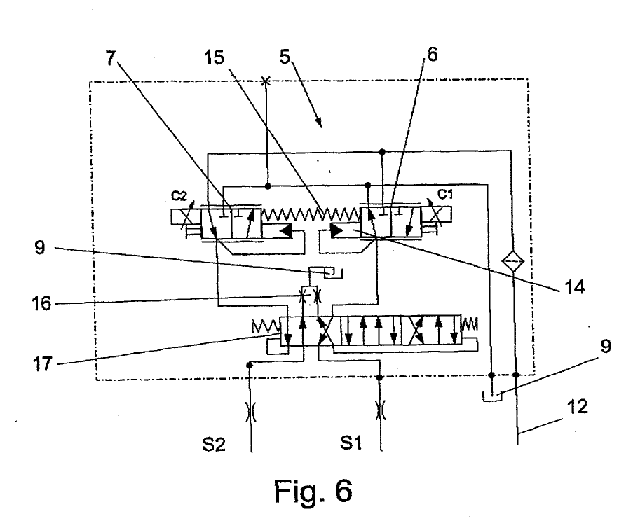

FIG. 6 shows the same circuit as before, with the proportional pressure-reducing valve 7 of the valve arrangement 5 now being activated. However, as a result, it does not require any connection to its servo side S2 but rather displaces the control piston 17 into an end position. Only by this means is the other proportional pressure-reducing valve 6 activated and operational by the connection of the servo side Sl to the other servo side S2 being interrupted via the nozzles 16. At the same time, the valve 6 requires a connection to the servo side 51. In this case, the control piston 17 is relieved of pressure on its end side (on the right in the drawing) towards the tank 9 via the orifice arrangement 16.

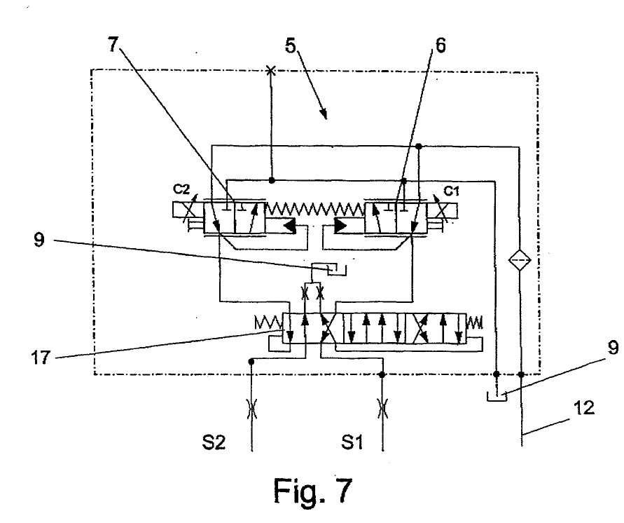

When the solenoid Cl is activated, the servo side Sl is connected to the pressure supply of the auxiliary circuit 12, as illustrated in FIG. 7. The proportional pressure-reducing valve 6 can therefore now control the associated servo side Sl in accordance with the energization of the solenoid Cl and the counterforces built up by the restoring spring and the pressure-recycling means 14.

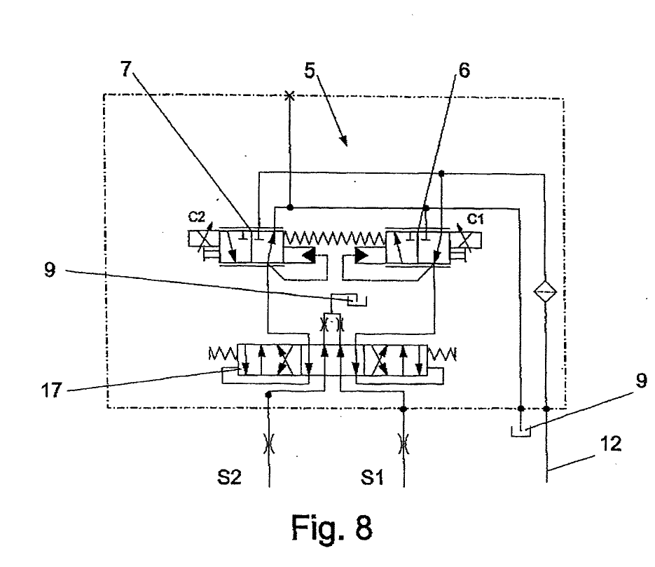

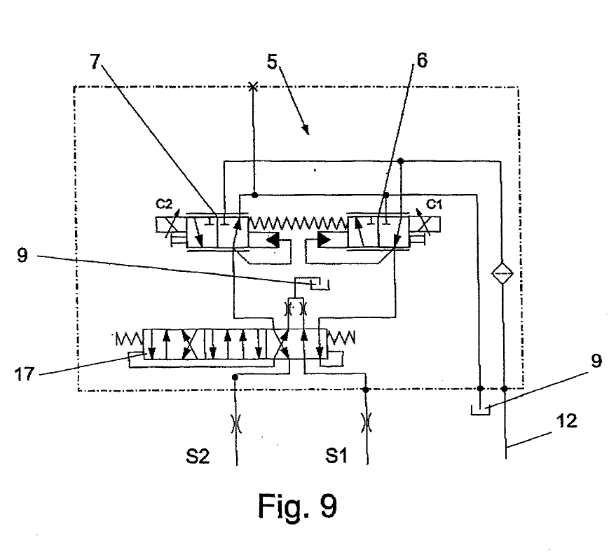

If the proportional pressure-reducing valve 7, as shown in FIG. 8, is then deactivated again, then the control piston 17 drops back again into its central position, but does not remain there because the other proportional pressure-reducing valve 6 is still active and continues to displace the control piston 17 in the direction of the other end position. This is apparent from FIG. 9. The proportional pressure-reducing valve 7 acting previously as the pilot valve is deactivated. The control piston has been displaced by the proportional pressure-reducing valve 6 into the end position which is on the left in the drawing. The proportional pressure-reducing valve 7 is therefore now operationally ready to control the servo side S2 while the proportional pressure-reducing valve 6, for its part, takes on the role of the pilot valve.

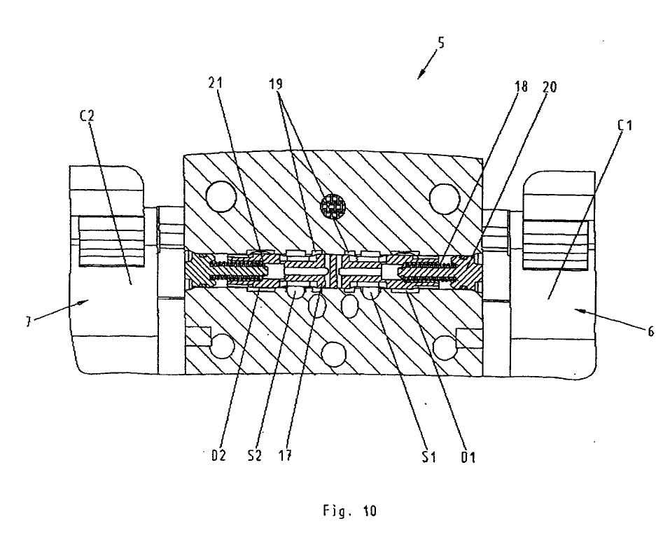

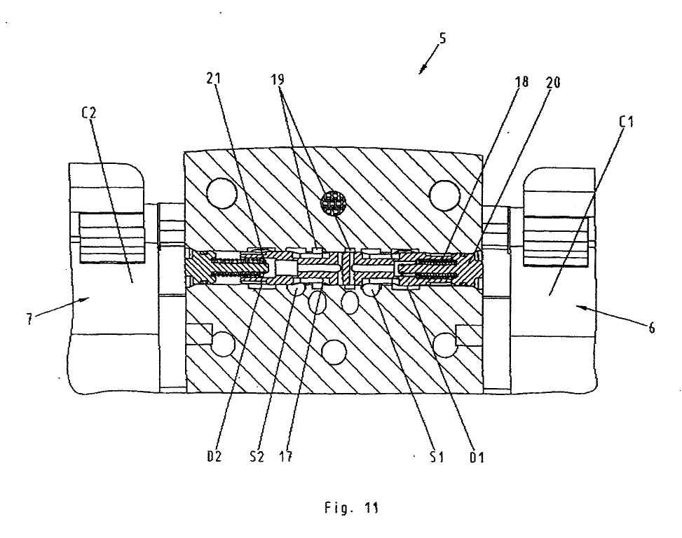

FIGS. 10 and 11 illustrate a specific design of the valve unit with the common control piston in a centred position (FIG. 10) and deflected (FIG. 11). The valve unit 5 comprises the two proportional pressure-reducing valves 6, 7 with the solenoids Cl and C2 which are respectively assigned to a servo side S1, S2. The control piston 17 is kept in a neutral position (FIG. 10) by means of a spring-centring means which is realized by two identical units on both sides of the control piston 17 and essentially comprises a rod guide 20 with a spring 18 preloaded thereon and with a disc 21 which is displaceable in one direction and has a stop in one direction. In this starting position illustrated in FIG. 10, the two servo sides Si and S2 are relieved of load towards the tank via the tank connections 19. By means of the respective starting pressure lines Dl, D2, which are assigned corresponding control edges in the cylindrical piston guide, each end side of the control piston 17 can be acted upon by the starting pressure of the particular proportional pressure-reducing valve.

In FIG. 11, the solenoid C2 of the proportional pressure-reducing valve 7 is active. The control piston 17 receives pressure on the associated end side and is pushed into its end position which is on the right in the drawing, as ‘a result of which the proportional pressure-reducing valve 6, as described with reference to FIGS. 5 to 9, is activated.

In the centrally centered position, the control piston 17 therefore keeps the control lines of both proportional pressure-reducing valves separate from the associated servo sides, connects both servo sides to the tank and connects each of its end sides to the starting pressure of one of the proportional pressure-reducing valves. When one of its two end sides is pressurized, it is displaced counter to the spring forces in such a manner that it continues to remain connected by this end side to the starting pressure of the associated proportional pressure-reducing valve, now the pilot valve, but the other end side loses its connection to its proportional pressure-reducing valve and instead is connected to the tank. The pilot valve continues to remain separated from its associated servo side. The latter is relieved of load towards the tank. By contrast, the other servo side finally exchanges its connection to the tank for the starting pressure of the associated proportional pressure-reducing valve when the latter is subsequently activated.

In summary, this results in the following manner of operation:

| | |
|---|---|
| Valve 7/C2 energized and | Control not active |
| valve 6/C1 unenergized | |
| then valve 6/C1 energized | Control on 6/S1 active |
| then valve 7/C2 unenergized | Control not active |
| then valve 7/C2 energized | Control on 7/S2 active |
| (6/C1 is still energized) | |
| then valve 6/C1 unenergized | Control not active |
| then valve 6/C1 energized | Control on 6/C1 again |
| (7/C2 is still energized) | active |
| etc. | |

This means, by way of example, for the following incidents:

| | |
|---|---|
| Cable break at the active | Control becomes/remains |
| solenoid: | inactive |
| Cable break at the pilot | Control becomes/remains |
| solenoid: | inactive |
| Active solenoid valve 7 | Pilot solenoid 6 deactivates |
| jams: | the control, controlled |
| | reverse travel through valve |
| | 6 is stills possible |

The system can therefore react appropriately to a jamming proportional pressure-reducing valve, to cable breakage or an electric short-circuit without additional actuators being required.

1. Hydrostatic variable unit with a servo system bringing about the adjustment of the hydrostatic unit and with a valve unit controlling the servo system,
the valve unit having a safety function which, in the event of an incident, transfers the servo system into a safety position,
the valve unit comprising two magnetically actuated proportional pressure-reducing valves,
the proportional pressure-reducing valves respectively acting upon one of the sides of a servo system, which sides operate counter to each other, and
the safety function being realized by at least one of the proportional pressure-reducing valves being designed at the same time as a pilot valve for activating and deactivating the second proportional pressure-reducing valve.

2. Hydrostatic variable unit according to claim 1, in which the proportional pressure-reducing valve operating as the pilot valve is assigned a control piston which, as a function of its position, activates or deactivates the servo side assigned to the second proportional pressure-reducing valve.

3. Hydrostatic variable unit according to claim 1, in which the proportional pressure-reducing valves are mutually designed in each case as a pilot valve for activating and deactivating the respectively other proportional pressure-reducing valve.

4. Hydrostatic variable unit according to claim 3, in which a single control piston is provided for both proportional pressure-reducing valves.

5. Hydrostatic variable unit according to claim 4, in which the control piston has a spring-centered neutral position.

6. Hydrostatic variable unit according to claim 4, in which the spring centering of the control piston is realized by two identical centering devices on both sides of the control piston, the centering devices each having a rod guide with a spring pre-stressed thereon and with a disc which is displaceable in one direction and has a stop in the opposite direction.

7. Hydrostatic variable unit according to claim 4, in which the control piston is arranged between opposite flanges of solenoids in such a manner that the flanges seal the control-piston bore.

8. Hydrostatic variable unit according to claim 1, in which the deactivation of the proportional pressure-reducing valve comprises the interruption of the control lines between the proportional pressure-reducing valve and its assigned servo side.

9. Hydrostatic variable unit according to claim 8, the assigned servo side being relieved of load towards the tank.

10. Hydrostatic variable unit according to claim 8, both servo sides being relieved of load simultaneously towards the tank.

11. Hydrostatic variable unit according to claim 8, both servo sides being connected to each other with the pressure being equalized.

12. Hydrostatic variable unit according to claim 11, both servo sides being relieved of load at the same time towards the tank.

13. Hydrostatic variable unit according claim 1, in which the deactivation comprises the interruption of the control lines for supplying pressure for the second proportional pressure-reducing valve.

14. Hydrostatic variable unit according to claim 13, the control lines for supplying pressure for the second proportional pressure-reducing valve being relieved of load towards the tank.

15. Hydrostatic variable unit according to claim 13, at least one servo side additionally being relieved of load towards the tank.

16. Hydrostatic variable unit according to claim 15, in which both servo sides are bypassed.

17. Hydrostatic variable unit according to claim 10, in which different orificing with a different delay of the tank-discharge operation is provided in the tank-discharge operations of the servo sides.
